(19) United States
(12) Patent Application Publication
(10) Pub. No.: US 2015/0128867 A1
(43) Pub. Date: May 14, 2015

(54) Feeding Apparatus, Method, and System

(71) Applicant: Chance Daniel KEITH, Magnolia, AR (US)

(72) Inventor: Chance Daniel KEITH, Magnolia, AR (US)

(21) Appl. No.: 14/077,940

(22) Filed: Nov. 12, 2013

(51) Int. Cl. A01K 5/00

(52) U.S. Cl. CPC A01K 5/008
USPC 119/65

(57) ABSTRACT

A feed bag apparatus may generally be described. The feed bag apparatus may include a fabric bag, the fabric bag having a sealable opening proximate a top portion of the bag, a tapered shape terminating at a bottom portion of the bag, an opening at the bottom portion of the bag that facilitates a gravity feed for food, and a hollow interior of the bag. The feed bag apparatus may further have a number of grommets located on a top portion of the fabric bag proximate the sealable top portion, the grommets facilitating coupling of the fabric bag to a support. Additionally, the feed bag apparatus may be substantially waterproof and weatherproof.

### BACKGROUND

Wildlife and domestic animals are currently fed in a variety of manners. Typical methods for feeding wildlife, whether to sustain the population or to act as a lure, involve hand or machine dispersal of food on a ground area. Alternatively, food can be placed in troughs or other open containers. However, common foods used for wildlife feed, such as rice bran, are then exposed to the elements, such as rain. The food then gets wet and spoils quickly, rendering it unsuitable for wildlife consumption.

Although troughs or feed areas can be made that have covers that protect the food from rain, such implementations are undesirable. The transport or assembly of a trough can be cumbersome and typically requires multiple people to set up. Further, although they may be covered directly overhead, wind or other environmental factors can cause moisture to contact the food, spoiling it. Further, animals can knock over or otherwise displace a trough, rendering it unusable or spoiling the food housed therein.

Still other types of feeders, particularly those used for deer, are rigid-walled feeders that utilize a gravity feed for providing food to a tray or dispersal area. These feeders, however, are subject to clogging and typically are unsuitable for powderized food, such as rice bran. In such rigid-walled feeders the powderized food can clog or become fixed in corners or angles of the feeding mechanism. The clogging prevents the food from being properly dispersed and therefore causes the food to sit in such a fashion that it can not be eaten and often spoils. Additionally, the clogging causes a need for maintenance to be performed on the rigid-walled feeder, thus leading to additional time needed to fix or clean the feeder.

### SUMMARY OF THE INVENTION

In one exemplary embodiment, an apparatus for feeding animals may be described. The feed bag apparatus may include a fabric bag, the fabric bag having a sealable opening proximate a top portion of the bag, a tapered shape terminating at a bottom portion of the bag, an opening at the bottom portion of the bag that facilitates a gravity feed for food, and hollow interior of the bag. The feed bag apparatus may further have a number of grommets located on a top portion of the fabric bag proximate the sealable top portion, the grommets facilitating coupling of the fabric bag to a vertical support. Additionally, the feed bag apparatus may be substantially waterproof and weatherproof.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary diagram showing a feeding device.

FIG. 1a is an exemplary cutaway diagram showing a feeding device.

FIG. 2 is an exemplary diagram showing a feeding device coupled to a tree.

FIG. 3 is an exemplary diagram showing a feeding device with dispensed food.

FIG. 4 is an exemplary diagram showing a feeding device with a mechanized food dispenser.

### DETAILED DESCRIPTION

Aspects of the present invention are disclosed in the following description and related figures directed to specific embodiments of the invention. Those skilled in the art will recognize that alternate embodiments can be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

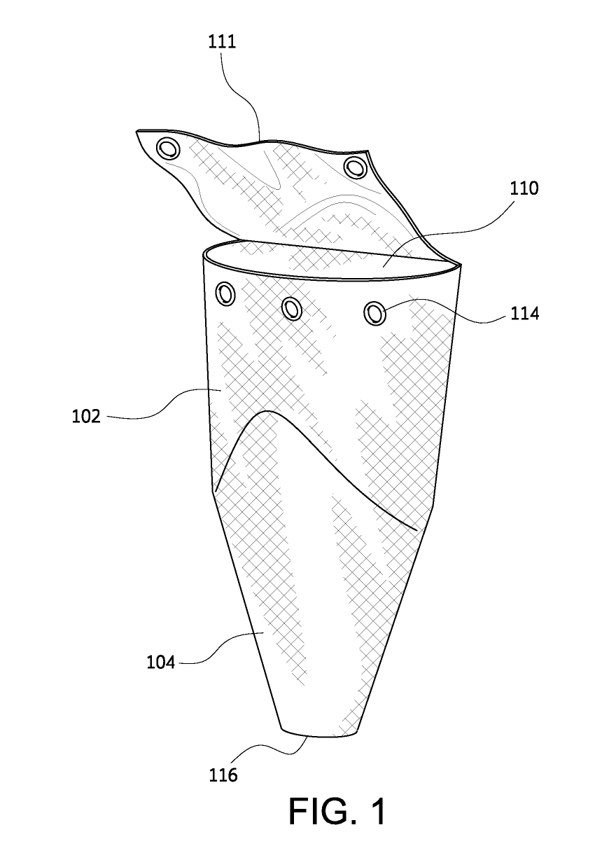

Generally referring to FIGS. 1-4, a feeding device may be described. The feeding device can be formed substantially out of fabric and may have a substantially open bottom portion. A resealable opening may be provided on a top portion of the device that can allow for the insertion of food products while also protecting inserted food products from outside elements. Additionally, any number of elements or structures that may facilitate fastening of the feeding device may be disposed on various portions of the device.

Referring now to exemplary FIG. 1, a feeding device may be shown. Feeding device 100 may be shaped in any of a variety of manners and may be formed in any of a variety of materials. For example, feeding device 100 may be formed as a bag 102. Bag 102 may further be formed using a fabric, a combination of fabrics, or a combination of fabrics and various coatings. In one exemplary embodiment, bag 102 may be formed with a fabric that is coated or otherwise infused with a composite material. Examples include, but are not limited to, coated or laminated nylon and polyester cloth or cloths. Such fabrics, or any other material used in the formation of bag 102, may be such that they provide an effective seal between an inside portion 103 of bag 102 and any outside elements. Thus, it may be appreciated that bag 102 may be substantially waterproof, weatherproof, water resistant, or otherwise protect anything housed inside bag 102 from weather or other outside elements. Any fabric or other material used in the formation of bag 102 may further have a high tensile strength. Therefore, bag 102 may be filled with any desired material, for example a type of food, such that bag 102 may contain the material without ripping or tearing, or otherwise deforming in an undesired manner. In some examples, the bag may be able to hold any amount of material without failing, such as about fifty pounds to two hundred pounds or more. However, should a tear or other defect become apparent, bag 102 may be patched quickly and easily using a patch of any desired material, allowing continuous use of bag 102 with limited maintenance or down time.

In still further exemplary embodiments, the bag may be formed in any of a variety of manners. In one embodiment, the bag may be formed with a pattern and in a substantially cylindrical shape so as to support a gravity feed of food from a top portion to a bottom portion of bag 102 with substantially no obstructions from top to bottom. Further, some embodiments may utilize textiles cut into shapes, for example “V” shapes, and in panels of different widths. Such panels may be sewn together, welded together, or otherwise coupled to provide a substantially water and weather proof seal.

Bag 102 may be formed in such a manner and out of such materials that it is easily collapsible and foldable. Additionally, bag 102 may be such that it is lightweight, for example approximately five pounds or less. Additionally, due to its construction, bag 102 may be substantially flexible or durable, for example remaining intact despite being fastened to a rough surface, such as tree bark. Additionally, bag 102 may be moved or bitten by any of a variety of animals without ripping, tearing or deforming in an undesirable manner.

Still referring to exemplary FIG. 1, bag 102 may have a substantially tapered shape or appearance from a top portion 106 to a bottom portion 104. Such a shape may allow for a gradual release of any material inside bag 102, for example food housed in bag 102. Additionally, bag 102 may have a top opening 110. Top opening 110 may be found in any of a variety of locations, such as a top end of bag 102 or on a side portion of bag 102 near a top end of bag 102. Top opening 110 may be such that it is sized to accommodate the insertion of food from any desired source. Top opening 110 may be sealable or resealable as well. For example, top opening 110 may have a securely fastenable flap 111, a securely fastenable lid, a zippered opening, a series of fasteners, a drawstring, or any other secure sealing mechanism or combination thereof. Such sealing mechanism may be such that it can further act to seal bag 102 from any outside elements while also preventing undesired or inappropriate access by any animals, such as birds or deer. Alternatively top opening 110 may be located on a side portion of bag 102, for example near the top of bag 102, and may be sealed in other fashions, for example using a drawstring, a moveable flap at the top of the bag that provides further sealing, zipper or any other known or desired mechanism for sealing a bag.

Additionally, bag 102 may have any desired fastening elements or fastening capabilities thereon or associated therewith. In one exemplary embodiment, bag 102 may be fastened to a support, such as a tree, using any desired rope, strap or flexible cords to secure the bag thereto. Thus, in one example a rope or series or ropes could simply be tied around bag 102 to secure it at a desired height and location. In another exemplary embodiment, a number of grommets 114 may be located on bag 102. Grommets 114 may be at a top portion of bag 102 as well as any other portion of bag 102, such as a middle or substantially middle portion. In such embodiments, bag 102 may be secured to a tree or other support using bungee cords where hooks on the cords are inserted in the grommets to facilitate securing bag 102. Such embodiments of bag 102 may also be fastened to a support by threading rope, wire, or other strapping mechanisms through the grommets and around the support. Also, the at least one grommet may be used to hang bag 102 from a hook, nail, or other hanger suspended by a support. In still other examples, any number of hooks may be disposed about bag 102 that may allow for direct coupling to a support structure or may be used in conjunction with rope or cord to secure bag 102 to a support structure. Yet another embodiment of bag 102 may include a loop or strap for hanging bag 102 from a support, or for easy carrying and maneuvering of bag 102 when either full of feed or empty. The loop or strap may disposed on a top portion or side portion of bag 102 and may be made of the same material as bag 102 or any other material reasonably understood by a person having ordinary skill in the art.

In further exemplary embodiments, bag 102 may be formed with any desired size. In one embodiment, and referring now to the exploded view of FIG. 1a, bag 102 may be about 61″ in length. The top portion 106 may have a total width of about 36″. A tapered portion at a lower end of bag 102 may be formed to have a funnel area about 28″ in height on front side 107 of bag 102. Rear side 108 of bag 102 may have a tapered lower portion of about 11.25″ in height. Thus, when front side 107 and rear side 108 are coupled together, a funnel portion of bag 102 may allow for both funneling action and sloped action of food or other material housed in bag 102. This can allow for increased friction, slowing the flow of gravity fed food from a top portion 106 to a bottom portion 104 of bag 102. Additionally, when coupled with a seal formed at bottom portion 104 of bag 102, this may allow for a desired flow and dispensing of food from bag 102.

Still referring to exemplary FIG. 1a, bottom opening 116 may be formed to have a diameter of about 4″ to about 6″. It may be appreciated, however, that the above dimensions may be varied based on any of a variety of factors, such as the height of a support to which bag 102 will be coupled, the type of food or other materials housed in bag 102, the type of environment where bag 102 will be used, or any other desired factors. For example, opening 116 may be adjustable so as to accommodate different release rates for a particular type of food or may be adjusted based on the type of food used in bag 102, for example powdered food or granular food. Also, top opening 110 may be substantially square shaped and may have sides with lengths of about 12″. A correspondingly sized flap 111 may be used to securely cover and seal, as desired, top opening 110.

In still other exemplary embodiments, bag 102 may be used in conjunction with one or more other bags. For example, bag 102 may be an interior bag fitted inside of an exterior bag. Bag 102 may continue to function as described herein, and an exterior bag may provide any other protection from the elements. For example, an exterior bag may be formed of a waterproof plastic or composite material that can be used to provide additional sealing or protection qualities to feeding device 100 and feed bag 102. Alternatively, an exterior bag may be utilized for other protective qualities or other appearance qualities. For example an exterior bag may be branded in any desired fashion, may have any desired decorative or functional patterns disposed thereon, such as camouflage, or may be colored in any desired fashion, for example blaze orange. In still further exemplary embodiments, an exterior bag can provide additional support, fastening or coupling elements that allow for a desired securing and range of movement of feeding device 100.

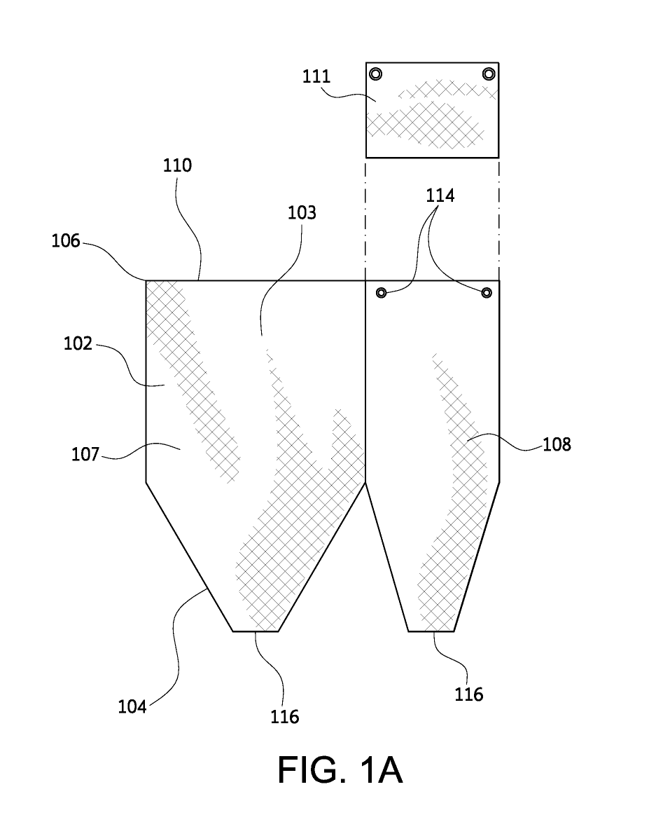

In another embodiment, and referring now to exemplary FIG. 2, bag 102 may be coupled to any desired support, for example tree 200. It may be appreciated that bag 102 could be coupled to any other desired support, such as a pole, the side of a building or otherwise supported, for example by hanging from a horizontal support, such as a tree branch, or supported by a tripod or other support mechanism. For example, a tripod may have a hanger located on a top portion thereof. A winch and wiring system may be associated with the hanger so as to allow for the hanging of bag 102 at any desired height, for example a height of approximately 2″ to approximately 6″ off the ground.

Still referring to exemplary FIG. 2, bag 102 may be secured to tree 200 at any desired height. In some exemplary embodiments, bag 102 may be secured so that bottom portion 104 is approximately 2″ to approximately 6″ off the ground. Alternatively, any other desired height off of the ground may be utilized, as desired. Further, the height of bag 102 off the ground may be adjusted in any desired increments after bag 102 is secured. Adjustments to the height of bag 102 may be made through manual loosening of any securing device, such as cords 202, or, in some exemplary embodiments, bag 102 may have an extendible bottom portion 104 that may elongate or otherwise pull out to allow for bag 102 to be closer to or father away from the ground.

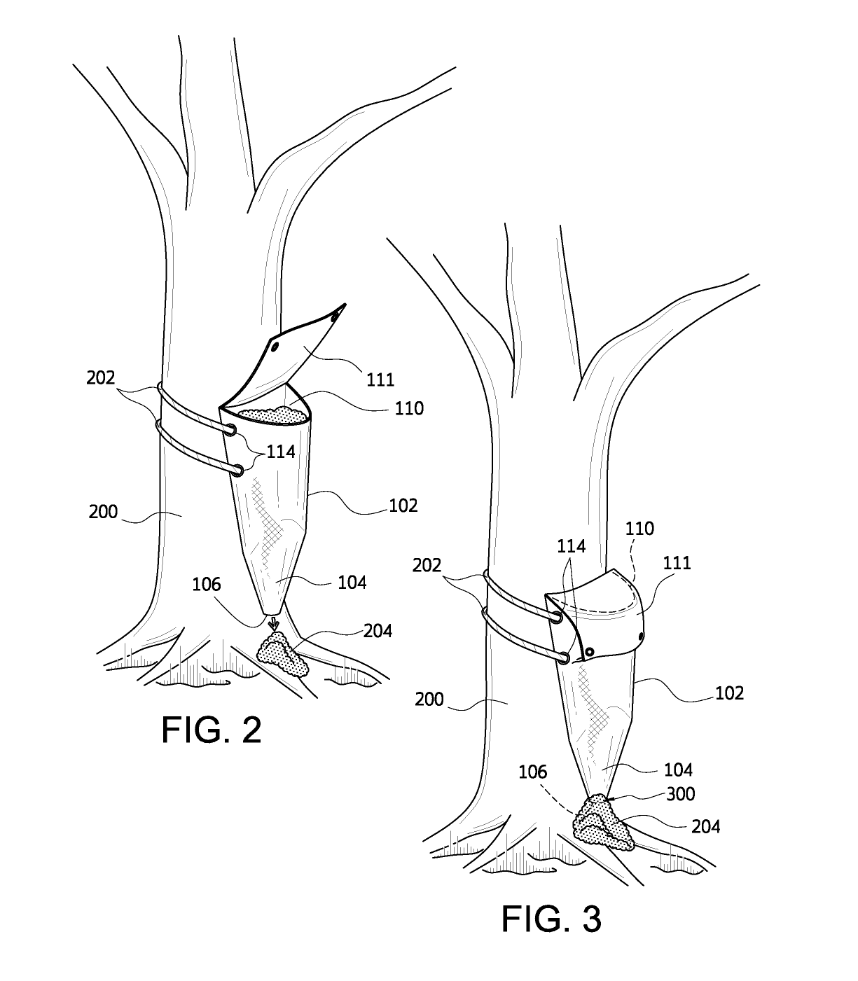

In further exemplary embodiments, the height of bag 102 off of the ground may be varied based on any of a variety of situations. For example, flap 111 may be open, allowing bag 102 to be filled with a type of food. Then gravity may cause the food to move from a top portion of bag 102, through inside portion 103, to bottom portion 104 and, ultimately, through an opening 116 at bottom portion 104 of bag 102. The food may then be deposited on the ground. However, if bottom portion 104 of bag 102 is located a desired distance off the ground, the food may pile or stack on the ground in a substantially conical or pyramidal shape 204 as it exits bag 102. The food 204 will then pile or stack until the food meets bottom portion 104 of bag 102. The piling or stacking of the food may be such that, as it meets bottom portion 104 of bag 102, it substantially seals bottom portion 104 of bag 102 such that the flow of food from bag 102 to the ground ceases. No more food may flow from bag 102 to the ground until the food is eaten or otherwise displaced to remove the effective seal and allow for additional food to be released. This may be further shown in exemplary FIG. 3.

After bag 102 is secured to tree 200, it may be filled with any desired material. In one exemplary embodiment, bag 102 can be filled with rice bran, a food desirable to deer, although any type of food, including granules, minerals, powders, or other food items may be utilized. It may be appreciated that any other desired food which may be suitable or desirable to any other type of animal may be used with bag 102, however. The food may be inserted through top opening 110 and, after the food is inserted, top opening 110 may be sealed so as to prevent any undesired access and keep bag 102 weatherproof. Further, it may be noted that while bag 102 is being filled, opening 116 on bottom portion 104 may be left open. In such embodiments, food may flow through bag 102 onto the ground until it creates a seal at bottom portion 104 of bag 102, allowing bag 102 to be filled to a desired level. Alternatively, opening 116 may be closed and sealed while bag 102 is filled. Opening 116 may be closed and sealed in any desired manner, for example through use of a drawstring or any other known closing and sealing mechanism.

Referring now to exemplary FIG. 3, bag 102 is shown secured to tree 200. Additionally, food 204 is shown as having flowed from bag 102 to the ground and top portion 110 has been sealed with flap 111 to protect the food from any outside elements. In this exemplary view, a seal 300 is created between bag 102 and the ground so that no further food may flow from bag 102. The bag may remain in this position until food 204 is eaten or otherwise dispersed, breaking seal 300. In one example, an animal, such as a deer, may eat some or all of food 204. This may allow for the release of more food from bag 102 as the seal 300 between opening 116 and the food pile is broken. Alternatively, if a strong wind or other weather conditions cause food 204 to disperse and break the seal 300, additional food may be released from bag 102. In a further exemplary embodiment, a deer or other animal may nudge, manipulate or otherwise move bag 102, breaking seal 300 and causing the release of additional food. Such movement may be possible because bottom portion 104 of bag 102 may not be secured directly to tree 200. For example, only top portion 102 may be secured to tree 200, allowing bottom portion 104 to move, be adjusted or, for example, be nudged or displaced by an animal to cause the release of more food. Additional food may be dispersed or released until bag 102 is empty. At that point, bag 102 may be refilled, as desired. Further, it may be noted that cords 202 may act to securely couple bag 102 to tree 200 in such a fashion that weather conditions or any interaction with animals will not cause an undesired movement or displacement of bag 102.

In still another exemplary embodiment, bag 102 may utilize a timed broadcast or release system. In these exemplary embodiments, a timing system may automatically meter the amount of food dispersed from bag 102. The timing system may be such that food may be automatically dispensed at a desired or predetermined time. In some exemplary embodiments, food may be dispensed when it is determined that there is insufficient or an undesired amount of food available on the ground for animals. Such determinations may be made automatically or through the assistance of a remotely located camera and monitoring system. In such embodiments, a remote control or any other known transmitter may be utilized to provide a signal to a receiver or transceiver located on bag 102. Such a signal may prompt the actuation of a flap or spinner to dispense food.

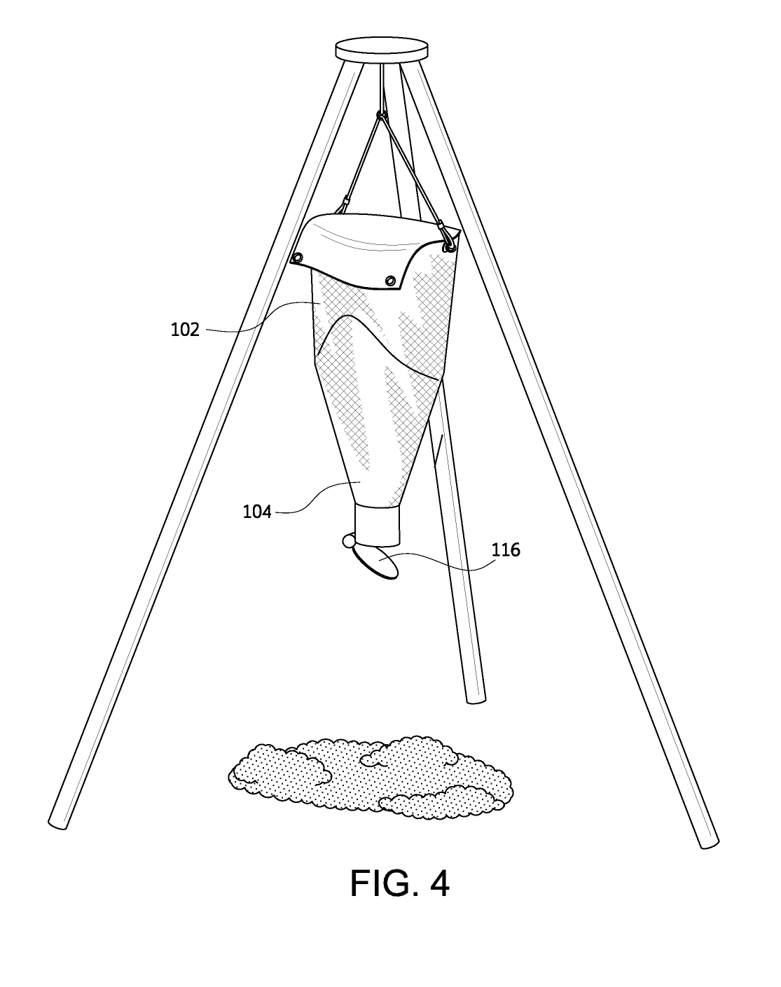

In such exemplary embodiments, and referring now to exemplary FIG. 4, a timed broadcast or release system may be integrated with bag 102 in any of a variety of manners. For example, an actuated flap may be utilized at bottom portion 104 of bag 102. The actuated flap may act to open and close opening 116. Any actuation of an actuated flap may be performed by a powered motor, for example a servo motor. Further, a battery or any other desired power source may be used to power the actuated flap or any other automated mechanism associated with bag 102. Additionally, in some exemplary embodiments, an actuated flap may be activated based on timing controls, based on a received instruction from a remote control, or manually, as desired. In some other exemplary embodiments, the actuated flap may be associated with or may act as a spinner, allowing for a broader spread or dispersal of food.

The foregoing description and accompanying figures illustrate the principles, one or more embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A feed bag apparatus, comprising:
a fabric bag, the fabric bag having a sealable opening proximate a top portion of the bag, a tapered shape terminating at a bottom portion of the bag, an opening at the bottom portion of the bag that facilitates a gravity feed for food, and a hollow interior of the bag;
one or more fasteners located on a top portion of the fabric bag proximate the sealable top portion, the fasteners facilitating coupling of the fabric bag to a support;
wherein the fabric bag is weatherproof.

2. The feed bag apparatus of claim 1, further comprising a seal formed between gravity fed food and the bottom portion of the fabric bag.

3. The feed bag apparatus of claim 1, wherein the plurality of fasteners are coupled with cord to couple the bag to a support.

4. The feed bag apparatus of claim 1, wherein the bag secures food against outside elements.

5. The feed bag apparatus of claim 1, wherein an amount of food dispensed from the bag is adjusted by varying a height that the bag is secured on a support.

6. The feed bag apparatus of claim 5, wherein food is dispensed when there is a distance between the bottom portion of the bag and a ground surface.

7. The feed bag apparatus of claim 1, wherein the fabric is nylon.

8. The feed bag apparatus of claim 1, wherein the fabric is a laminated nylon.

9. The feed bag apparatus of claim 1, further comprising a front portion with a first tapered portion with a first height and a back portion with a second tapered portion with a second height.

10. The feed bag apparatus of claim 9, wherein the first height is greater than the second height.

11. The feed bag apparatus of claim 1, wherein the open bottom portion is sealable.

12. The feed bag apparatus of claim 1, wherein the open top portion is sealable.

13. The feed bag apparatus of claim 1, further comprising an actuated flap that covers the opening at the bottom portion of the bag.

14. The feed bag apparatus of claim 1, wherein the support is one of a vertical support, horizontal support or a tripod.

15. The feed bag of claim 1, wherein the plurality of fasteners are at least one of grommets and hooks.

16. The feed bag of claim 1, further comprising an automated dispensing mechanism located at the bottom portion of the bag.

17. The feed bag of claim 16, wherein the automated dispensing mechanism dispenses food at predetermined times.

18. The feed bag of claim 16, wherein the automated dispensing mechanism dispenses food in response to a received signal.
